(19) United States
(12) Patent Application Publication
(10) Pub. No.: US 2014/0079219 A1
(43) Pub. Date: Mar. 20, 2014

(54) SYSTEM AND A METHOD ENABLING SECURE TRANSMISSION OF SMS

(71) Applicants: Ugur Yigit, Istanbul (TR); Alp Sardag, Istanbul (TR)

(72) Inventors: Ugur Yigit, Istanbul (TR); Alp Sardag, Istanbul (TR)

(73) Assignee: TURKCELL ILETISIM HIZMETLERI ANONIM SIRKETI, Istanbul (TR)

(21) Appl. No.: 14/009,155

(22) PCT Filed: Apr. 2, 2012
(86) PCT No.: PCT/IB12/51609

§ 371 Date: Dec. 1, 2013

(30) Foreign Application Priority Data
Apr. 1, 2011 (TR) 2011/03175

(51) Int. Cl. H04W 12/02; H04W 4/14

(52) U.S. Cl. CPC H04W 12/02; H04W 4/14
USPC 380/270

(57) ABSTRACT

The present invention relates to a system (1) and method (100) which enables the SMSs to be sent encrypted and to be opened only in the mobile devices (2), wherein the SIM card belonging to the MSISDN, to which they are sent, is installed. The inventive system (1) comprises a mobile device (2) which can run mobile application and in which a SIM card can be installed, a content sender (3) which sends the confidential information of its clients via SMS, a data-base (4) wherein the encryption keys produced specific to the SIM card by the SIM card producer are stored, an SMSC (5) which transmits the information it receives to the mobile device (2), an encryption platform (6) which encrypts the SMS that will be sent, and an OTP sending platform (7) which receives the SMS content from the content sender (3), sends it to the encryption platform (6) and sends the encrypted SMS it receives from the encryption platform (6) to the SMSC (5).

### FIELD OF THE INVENTION

The present invention relates to a system and a method which performs secure message transmission by enabling the SMSs (Short Message Service) to be sent encrypted and to be opened only in the mobile devices, wherein the SIM (Subscriber Identity Module) card belonging to the MSISDN (Mobile Subscriber Integrated Services Digital Network Number) to which they are sent, is installed.

### BACKGROUND OF THE INVENTION

Today, the remote communication devices becoming widespread makes the communication between the institutions and the people significantly easy. Although they make the communication easy, some problems occur in using these devices. The security problem of the shared information is the most important of these problems. Security measures should be increased as much as possible especially in the messages concerning bank transactions, the content of which is extremely important for the users such as security questions and one time passwords sent by way of SMS and which can cause financial loss for the user if third parties get hold of it.

Korean Patent document no KR20080030266A, an application known in the state of the art, discloses a method enabling the SMSs sent to be encrypted. First, the received SMS is controlled whether it is encrypted or not. If it is determined that the SMS is encrypted, the receiver is required to enter an encryption key value. If this key is same with the key determined by the sender, the content of the SMS is shown.

Great Britain Patent document no GB2415574, an application known in the state of the art, discloses a system for transmitting messages such as SMS messages and WAP push messages between devices registered with a telecommunication system. The messages are authenticated in the system. In order to see an authenticated message, the first device sends the key and the MSISDN information to the second device. This information is stored in the second device. Then the first device creates the message and hash value is calculated using the key of the first device. The secure message including the hash value and the message is transmitted to the second device and the hash value is calculated using the key of the first device which is stored and the MSISDN information of the first device. The message is opened in case the hash value composed in two different devices is the same.

### SUMMARY OF THE INVENTION

The objective of the present invention is to provide a system and a method enabling the sent SMSs to be read only in the SIM card belonging to the MSISDN to which they are sent.

A further objective of the present invention is to provide a system and a method which prevents the sent SMSs from being directed to other MSISDNs.

### DETAILED DESCRIPTION OF THE INVENTION

“A System and Method Enabling Secure Message Transmission” developed to fulfill the objective of the present invention is illustrated in the accompanying figures, in which:

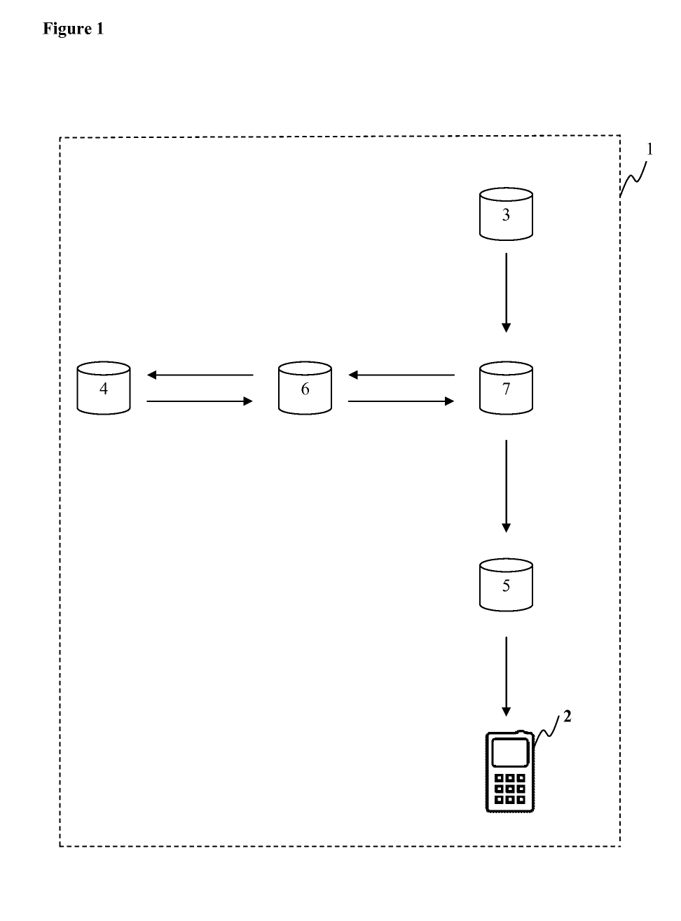

FIG. 1 is the schematic block diagram of the inventive system.

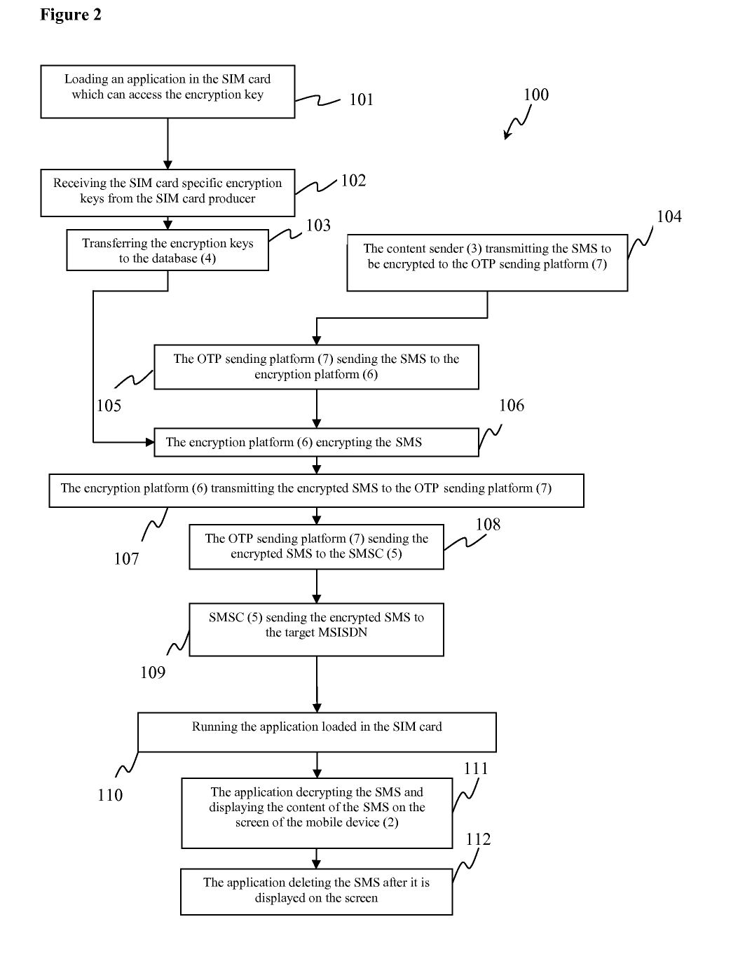

FIG. 2 is the flowchart of the method that operates the inventive system.

The components shown in the figures are each given reference numerals as follows:
1. System
2. Mobile device
3. Content sender
4. Database
5. SMSC (Short Message Service Center)
6. Encryption Platform
7. OTP (One Time Password) Sending Platform
100. Method

A system enabling secure message transmission (1) comprises
at least one mobile device (2) which can run mobile application and has at least one SIM card,
at least one content sender (3) which sends confidential information of the clients such as credit card information or one-time password via SMS,
at least one database (4) wherein the encryption keys produced specific to the SIM card by the SIM card producer are stored,
at least one SMSC (5) which transmits the information it receives to the mobile device (2),
an encryption platform (6) which encrypts the sent SMS,
an OTP sending platform (7) which receives the SMS content from the content sender (3), sends it to the encryption platform (6) and sends the encrypted SMS it receives from the encryption platform (6) to the SMSC (5) (FIG. 1).

In the preferred embodiment of the present invention, the mobile device (2) is a mobile phone and comprises at least one SIM card.

The content sender (3) is an establishment from which the subscriber gets service. In the preferred embodiment of the invention, the content sender (3) is a bank.

The content sender (3) composes the content of the SMS sent to the customers. Since the content includes information which will be unfavorable if third parties get hold of it such as one-time password and credit card information, they are sent by methods having high security measures.

The database (4) is the part wherein the encryption keys produced specific to the SIM card by SIM card producers are stored. The information about the SIM card belonging to the MSIDN, to which the SMSs are sent, are accessed from the database (4).

SMSC (5) is the center which enables the SMSs to be transmitted to the mobile device (2).

The encryption platform (6) encrypts the incoming content preferably according to the 3DES (Triple Data Encryption Standard) algorithm. In the preferred embodiment of the invention, the encryption platform (6), in addition to encrypting the SMS, converts the SMS into binary format and/or adds a code to the SMS. In other embodiments of the invention, different algorithms can be used instead of 3DES algorithm for encrypting the content.

In the inventive system (1), the SMSs are encrypted such that they will be opened only in the mobile device (2) in which the SIM card belonging to the MSISDN, to which they are sent, is installed. In accordance with the information in the content coming to the encryption platform (6), the MSISDN to which the SMS is sent is determined. The encryption keys concerning the SIM card belonging to the determined MSISDN are received from the database (4). The SMSs are encrypted according to a certain algorithm using encryption keys. In the preferred embodiment of the invention, SMSs are encrypted by the encryption platform (6) using encryption keys, according to the 3DES algorithm. OTP (One Time Password) sending platform (7) sends the content it receives from the content sender (3) to the encryption platform (6), and sends the encrypted SMS coming from the encryption platform (6) to the SMSC.

A method (100) enabling the SMSs to be sent to the mobile devices (2) upon being encrypted comprises the steps of
loading an application to the SIM card which can access to the encryption key (101),
receiving the SIM card specific encryption keys from the SIM card producer (102),
transferring the encryption keys to the database (4) (103),
the content sender (3) transmitting the SMS to be encrypted to the OTP sending platform (7) (104),
the OTP sending platform (7) sending the SMS to the encryption platform (6) (105),
the encryption platform (6) encrypting the SMS (106),
the encryption platform (6) transmitting the encrypted SMS to the OTP sending platform (7) (107),
the OTP sending platform (7) sending the encrypted SMS to the SMSC (5) (108),
SMSC (5) sending the encrypted SMS to the target MSISDN (109),
running the application loaded in the SIM card (110),
the application decrypting the SMS and displaying the content of the SMS on the screen of the mobile device (2) (111),
the application in the SIM card deleting the SMS after it is displayed on the screen of the mobile device (2) (112) (FIG. 2).

The inventive method (100) starts with loading an application to the SIM card that can access the encryption key in the SIM card (101). The encryption key is produced separately for each SIM card and loaded in the SIM card by the SIM card producer. The applications loaded in the SIM card have the required authorization to access the said key.

The information related to the encryption keys loaded in the SIM card by the SIM card producer is received from the producer (102) and transferred to a database (4) (103). Third parties getting hold of these keys will jeopardize the security of the subscriber's confidential information. For this reason in the preferred embodiment of the invention, the keys are stored encrypted in the database (4).

The SMS to be encrypted is transmitted to the OTP sending platform (7) by the content sender (3) (104). The unencrypted SMS coming to the OTP sending platform (7) is sent to the encryption platform (6) by the OTP sending platform (7) (105). The encryption platform (6) encrypts the SMS so that its content cannot be seen by third parties (106). In a preferred embodiment of the invention, encryption (106) is performed by the encryption platform (6) using the 3DES algorithm, by means of the encryption keys obtained from the SIM card producer. This way, the encrypted SMS is opened only in the mobile device (2) in which the SIM card belonging to the MSISDN, to which it is sent, is installed. In another embodiment of the invention, after the SMS is encrypted by the encryption platform (6) with the 3DES algorithm, it is converted into binary format by the encryption platform (6), and/or the encryption platform (6) adds a code into the SMS which addresses the application that is loaded in the SIM card and/or which associates the SMS and the application in the SIM card with each other. The encrypted SMSs are transmitted back to the OTP sending platform (7) by the encryption platform (6) (107). The OTP sending platform (7) sends the encrypted SMS to the SMSC (5) (108). SMSC (5) sends the incoming SMS to the target MSISDN (109).

The encrypted SMS reaching the SIM card is read by running (110) the application loaded in the SIM card. In the preferred embodiment of the invention, reaching of the SMS to the SIM card automatically runs the application loaded in the SIM card. The application loaded in the SIM card decrypts encrypted SMS and displays it on the screen of the mobile device (2) (111). The encrypted SMS is decrypted only by the help of the application loaded in the SIM card using the encryption keys on the SIM card and it is displayed on the screen of the mobile device (2). In the preferred embodiment of the invention, the SMS is displayed as a flash SMS on the screen of the mobile device (2) by the application loaded in the SIM card, and/or appearance and/or storing of the SMS coming to the mobile device (2) in the inbox of the mobile device (2) is inhibited by the application loaded in the SIM card, and/or the SMSs are automatically deleted by the application loaded in the SIM card after they are read (112). This way the SMS is prevented from being directed to other MSISDNs. Even if the SMSs are directed to another MSISDN by viruses or harmful software that infect the mobile device (2), since the encryption key loaded in the SIM cards will be different it will not be possible to read the SMSs at the said MSISDN to which they are directed.

By means of the inventive system (1) and the method (100), the sent SMSs are enabled to be displayed only in the mobile device (2) in which the SIM card belonging to the MSISDN, to which they are sent, is installed.

It is possible to develop a wide variety of embodiments of the inventive system (1) and method (100) enabling secure message transmission. The invention cannot be limited to the examples described herein and it is essentially as defined in the claims.

1. A method enabling SMSs to be sent to mobile devices upon being encrypted, the method comprising the steps of:
loading an application in a SIM card which can access at least one encryption key;
receiving the SIM card specific encryption key from a SIM card producer;
transferring the encryption key to a database;
transmitting the SMS to be encrypted to an OTP sending platform;
sending the SMS to an encryption platform;
encrypting the SMS;
transmitting the encrypted SMS to the OTP sending platform;
sending the encrypted SMS to a SMSC;
sending the encrypted SMS to a target MSISDN;
running the application loaded in the SIM card;
decrypting the SMS and displaying the content of the SMS on a mobile device; and
deleting the SMS after it is displayed on the mobile device.

2. The method according to claim 1, wherein the information related to the encryption key loaded in the SIM card by the SIM card producer is encrypted and stored in the database.

3. The method according to claim 2, wherein the SMSs are encrypted by the encryption platform by means of the SIM card-specific encryption key, which are obtained from the SIM card producer, according to a 3DES algorithm.

4. The method according to claim 1, further comprising decrypting the encrypted SMS loaded in the SIM card using the encryption key in the SIM card, and displaying the SMS content on the mobile device.

5. The method according to claim 4, wherein the SMSs are converted by the encryption platform into binary format.

6. The method according to claim 5, wherein the encryption platform is capable of adding a code into the SMS which addresses the application that is loaded in the SIM card, and/or associating the SMS and the application in the SIM card each other.

7. The method according to claim 6, further comprising running the application loaded in the SIM card when the SMS reaches the SIM card.

8. The method according to claim 7, wherein the incoming SMS is displayed as a flash SMS by the application loaded in the SIM card.

9. The method according to claim 8, further comprising inhibiting the display of the incoming SMS in the inbox of the mobile device.

10. The method according to claim 9, wherein the application is capable of inhibiting the storing of the incoming SMS.

11. The method according to claim 10, further comprising deleting the SMS after it is read.

12. A system enabling secure short message transmission comprising:
at least one mobile device which is capable of running a mobile application and in which at least one SIM card can be installed;
at least one content sender which is capable of sending confidential information of the clients such as credit card information or one-time password via SMS;
at least one database wherein the encryption key produced specific to the SIM card by the SIM card producer are stored;
eat least one SMSC (5) which is capable of transmitting the information to the mobile device;
at least one encryption platform which is capable of encrypting the SMS that will be sent; and
at least one OTP sending platform which is capable of receiving the SMS content from the content sender, sending it to the encryption platform and sending the encrypted SMS received from the encryption platform to the SMSC.

13. The system according to claim 12, wherein the mobile device is a mobile phone.

14. The system according to claim 12, wherein the content sender is a bank.

15. The system according to claim 14, wherein the database in which information related to the encryption key loaded in the SIM card by the SIM card producer is stored in an encrypted state.

16. The system according to claim 15, wherein the encryption platform is capable of performing encryption by means of a 3DES algorithm using SIM card-specific encryption key.

17. The system according to claim 16, wherein the application loaded in the SIM card is capable of decrypting the encrypted SMS and enabling the SMS content to be displayed on the mobile device.

18. The system according to claim 17, wherein the application loaded in the SIM card is capable of inhibiting displaying the incoming SMS in the inbox of the mobile device.

19. The system according to claim 18, wherein the application loaded in the SIM card is capable of inhibiting storing the incoming SMS.

20. The system according to claim 19, wherein the application loaded in the SIM card is capable of deleting the SMS after it is displayed on the mobile device.

21. The system according to claim 20, whereas in an application loaded in the SIM card is capable of running when the SMS reaches the SIM card.

22. The system according to claim 21, wherein the application loaded in the SIM card is capable of enabling the incoming SMS to be displayed as a flash SMS.

23. The system according to claim 22, wherein the encryption platform is capable of converting the SMS into binary format, and/or adding a code into the SMS that addresses the application that is loaded in the SIM card and/or associating the SMS and the application in the SIM card with each other.
